(19) United States
(12) Patent Application Publication
(10) Pub. No.: US 2026/0134700 A1
(43) Pub. Date: May 14, 2026

(54) Data Processing Device for a Parking System

(71) Applicant: Norbert Miller, Mönchengladbach (DE)

(72) Inventor: Norbert Miller, Mönchengladbach (DE)

(73) Assignee: Scheidt & Bachmann GmbH, Mönchengladbach (DE)

(21) Appl. No.: 19/380,030

(22) Filed: Nov. 5, 2025

(30) Foreign Application Priority Data
Nov. 8, 2024 (DE) 10 2024 132 714.6

(51) Int. Cl. G06V 20/62; G07C 1/30; G07C 9/10

(52) U.S. Cl. CPC G06V 20/625; G07C 1/30; G07C 9/10

(57) ABSTRACT

A data processing device for an off-street parking system and an off-street parking system and a method.

### CROSS-REFERENCE TO RELATED PATENT APPLICATION

This patent application claims the benefit of priority to German Patent Application No. 10 2024 132 714.6, filed Nov. 8, 2024, the entire teachings and disclosures are incorporated herein by reference thereto.

### FIELD OF THE INVENTION

The invention relates to a data processing device for an (off-street) parking system. In addition, the invention relates to an (off-street) parking system and a method.

### BACKGROUND OF THE INVENTION

Parking systems with at least one parking device are known from the prior art. A parking device is, in particular, a parking garage or a parking lot. Such parking systems are also referred to as off-street parking systems respectively off-street parking facilities.

Such a parking system usually comprises one or more vehicle access devices at a corresponding number of drive throughs to and/or from a parking device. For example, a vehicle access device with a blocking element, such as a barrier with a swiveling barrier arm, may be provided. With such a vehicle access device, in particular, a driving through of a vehicle is controlled respectively regulated through a drive through at which the vehicle access device is arranged from a first area into a further area.

In a parking system, for example, at least one vehicle access device can be provided to control the drive through of a vehicle from an uncontrolled area, such as a (public) road, into a controlled area, such as the parking area respectively the parking device. In other words, driving into the parking device can be controlled by a vehicle access device at an entry of the parking system. Alternatively or additionally, a parking system may be provided with at least one vehicle access device to control the driving through of a vehicle from the controlled area into the uncontrolled area. In other words, the driving out of a vehicle from the parking device at an exit may be controlled by a vehicle access device.

A vehicle access device with a blocking element or a vehicle access device without a blocking element (also referred to as a free-flow system respectively free-flow vehicle access device) may be arranged at an entry and/or exit. Entries and/or exits can be structurally separate, for example, with separate lanes for entry and exit and separate vehicle access devices, or combined, for example, with an entry and exit with a common lane and a common vehicle access device. Furthermore, at the entry and/or exit, several lanes may be located next to each other in one direction, in particular, with and without structural separation of the lanes.

In the case of known vehicle access devices, driving into a parking device is granted after a parking ticket, such as a short-term parking ticket, has been issued as a result of user action. The short-term parking ticket, in particular, a paper ticket, is then paid by a user at a ticket machine at the end of a parking period and parking duration, respectively, and checked at the exit by a validator device of the vehicle access device. If the checking is positive, the driving through of the drive through (in this case, the exit) by the vehicle is released by a release module. However, if the validator device determines that the ticket, for example, has not yet been paid for or that the payment is overdue, the vehicle access device remains closed and the drive through remained blocked. In other words, a driving through the drive through is blocked by a release module.

A constant concern in (off-street) parking systems is to improve user comfort. In particular, manual user actions are considered user-unfriendly. From the prior art, parking systems are already known in which the necessary user actions can be reduced.

For example, parking systems are known in which a license plate recognition equipment is provided at a drive through (in particular, at each drive through) each comprising at least one camera. The at least one camera of a license plate recognition equipment is configured to detect image data of a vehicle license plate of a vehicle driven through respectively driving through the corresponding drive through. This comprises, in particular, detecting the aforementioned image data before driving through the drive through.

The license plate recognition equipment may comprise the camera and an image evaluation module connected to the camera. The image evaluation module may be configured to determine a license plate string from the detected image data. Such a license plate recognition equipment (with camera and image evaluation module) is also referred to as an LPR equipment. In an LPR equipment, the image of the vehicle license plate detected by the camera is evaluated by the image evaluation module, in particular, by means of OCR (Optical Character Recognition) in order to determine the license plate string.

The license plate string is a string of characters that the license plate recognition equipment determines from the camera image respectively the image data from the camera and which, ideally, is the string of characters that corresponds to the license plate string on the license plate attached to the vehicle and shown in the detected image data.

In particular, in addition to the image data, the respective license plate recognition equipment can also determine the time point of driving through (in particular, an entry time point or an exit time point). A data processing device can be configured to evaluate the aforementioned data. For example, the data processing device can be configured to determine the parking duration from the difference between the entry time point and exit time point for the same license plate string respectively the same vehicle. In addition, access authorizations (e.g., long-term parking authorizations) can be linked to a vehicle license plate string, for example, stored in a data memory of a data processing device.

If the data processing device also determines that a short-term parker has paid the parking fee before leaving, e.g., at a payment machine, the vehicle license plate can be used to identify the parking process to be paid for during the payment process.

Although parking systems with a LPR license plate recognition equipment are advantageous in that they reduce user actions and thus improve user comfort, the systems known from the prior art have disadvantages in terms of reliability. Known dedicated license plate recognition camera systems (in particular, despite high system prices) only achieve an accuracy of 95-99% in determining the vehicle license plate, in particular, with regard to the correct reading of the vehicle license plate from the detected image data, such as an image sequence, at the entry or exit of a parking device.

An incorrectly determined license plate will be detected by the data processing device, in particular, if the exit license plate string determined at an exit is not identical to the entry license plate strings determined at the at least one entry of the parking device. In this case, a parking process cannot be unambiguously assigned to a vehicle; in particular, it is not possible to form and bill a completed parking process consisting of the parking duration of exactly one vehicle.

With a high number of parking processes, even a 99 % rate still leads to a correspondingly high number of problematic parking processes, which directly affect users and cause dissatisfaction. This leads, in particular, to reduced user comfort and a high level of support for the parking system operator. By way of comparison: A magnetic strip ticket or barcode ticket issued upon an entry process by a vehicle access device is read correctly in a payment machine and at the exit with a rate of better than 99.9 %.

From U.S. Pat. No. 11,488,471 B2 a parking system is known with a plurality of detection devices each comprising a camera (with image evaluation module) and a detector. A first detection device of this type is provided at an entry of the parking system to determine the license plate string of the vehicle driving in. At the same time, the detector of the detection device detects signals from wireless terminals and determines the respective identifiers of the wireless terminals, which are contained as data content in a signal. For this purpose, the detector must comprise, among other things, a decoder to determine the data content. Furthermore, the detector is configured to extract the wanted identifier from the determined data content.

A data set is then generated containing the identified license plate and the identified wireless terminal devices detected hereby. A large number of additional detection devices are distributed throughout the parking device of U.S. Pat. No. 11,488,471 B2. When a vehicle enters the detection range of such a device, the license plate and the identifiers located in the detection range are detected simultaneously and a corresponding data set is generated for each. From the large number of generated data sets with the same license plate, the most frequently occurring identifier is determined and identified as an alternative identifier to the license plate.

U.S. Pat. No. 11,488,471 B2 thus makes it possible to identify a vehicle using an identifier of a wireless terminal device as an alternative to the license plate. However, this does not lead to sufficient reliability: For example, there may be no wireless terminal device, i.e., a cell phone, in the vehicle, or there may be multiple wireless terminal devices in the vehicle so that a unique assignment cannot be made. In addition, the implementation effort is immense, since, on the one hand, the detector must be able to decode the signals and extract the wanted identifier from the decoded data content. On the other hand, corresponding detection devices must not only be arranged at the entry of the parking device, but also distributed throughout the entire area of the parking device. In particular, three or more data sets must be generated.

### SUMMARY OF THE INVENTION

Therefore, the object of the present invention is to provide a possibility with which the disadvantages of the prior art can at least be reduced and, in particular, with which an exit data set with a specific exit license plate string can be assigned to the correct entry data set with a specific entry license plate string with little effort and increased reliability, even if the respective license plate strings are not identical due to a license plate recognition error.

The object is solved according to a first aspect of the invention by a data processing device according to claim 1 for a parking system. The data processing device comprises at least one receiving module. The receiving module is configured to receive an entry data set, in particular, a plurality of entry data sets. An entry data set (in particular, each entry data set) contains an entry license plate string determined by a first license plate recognition equipment for a vehicle driving into a parking device of the parking system and at least one entry raw signal detected by an entry signal detection equipment in an entry area of the parking device during the driving in of the vehicle. The data processing device comprises at least one memory module. The memory module is configured to store the received entry data set in a data memory, in particular, to store all received entry data sets in the data memory. The receiving module is configured to receive an exit data set, in particular, a plurality of exit data sets. An exit data set (in particular, each exit data set) contains an exit license plate string of a vehicle driving out of the parking device determined by a second license plate recognition equipment, and at least one raw exit signal detected by an exit signal detection equipment in an exit area of the parking device during the driving out of the vehicle. The data processing device comprises at least one evaluation module. The evaluation module is configured to determine an entry data set corresponding to the received exit data set from the (respectively all) stored entry data sets by:
comparing, in a first comparison step, the exit license plate string of the exit data set with the respective entry license plate strings of the stored entry data sets, and
comparing, in a second comparison step, (only) the at least one exit raw signal of the exit data set with the entry raw signal of the at least one entry data set of the stored entry data sets which contains the entry license plate string that is most similar to the exit license plate string of the exit data set, at least if no entry license plate string was determined to be identical to the exit license plate string in the first comparison step.

A further aspect of the invention is a parking system according to claim 12. The parking system comprises at least one data processing device (according to claim 1) as described above. The parking system comprises at least one first license plate recognition equipment. The first license plate recognition equipment is configured to determine an entry license plate string of a vehicle driving into a parking device. The parking system comprises at least one entry signal detection equipment. The entry signal detection equipment is configured to detect at least one raw entry signal in an entry area of the parking device during the driving in of the vehicle. The parking system comprises at least one second license plate recognition equipment. The second license plate recognition equipment pieces configured to determine an exit license plate string of a vehicle driving out of the parking device. The parking system comprises at least one exit signal detection equipment. The exit signal detection equipment is configured to detect at least one exit raw signal in an exit area of the parking device while the vehicle is driving out.

An entry raw signal respectively exit raw signal (collectively referred to as “raw signal”) within the meaning of the invention is at least one signal, in particular, a radio signal, which is detected and processed by the entry signal detection equipment respectively exit signal detection equipment in an entry area respectively exit area of the parking device while the vehicle is driving in respectively driving out, however which is an uninterpreted informative signal, in particular, radio signal. The received and processed signal may be, for example, a Bluetooth advertisement signal. This signal is received and processed by a signal detection equipment, for example, an antenna, so that the signal content (as a raw signal) is available. In Bluetooth, this signal content comprises, for example, a so-called header and a so-called payload. In the sense of the invention, this is a raw signal, because knowledge of the structure of the signal is necessary to understand the information transmitted with the signal content. For example, it must be known that the raw signal contains the address (ID) of the transmitting device and where this can be found in the raw signal. The same applies to other information. If the structure of the raw signal is unknown, an informative interpretation is not possible. For example, it is conceivable that, in addition to Bluetooth, other signals are received that do not have a uniform and/or known structure. An example of this are signals from tire pressure sensors, whose structure can vary from manufacturer to manufacturer. However, for the present invention, an informative interpretation of the signals is not necessary and, in particular, does not take place, so that the signal contents of such signals whose structure is unknown can also be used as raw signals. The at least one detected signal results from at least one transmitting device (in particular, from a plurality of transmitting devices) that can be expected to be present in or at a vehicle respectively to be carried by it.

In contrast to the prior art, when driving in and driving out, raw signals from transmitting sources located in the vicinity of the vehicle during entry and exit are detected in addition to the license plate string of the vehicle and evaluated at least then if during a first comparison of an exit license plate string detected during driving out with the entry license plate strings of the stored entry data sets no identity can be determined, the disadvantages of the prior art are at least reduced. In particular, with little effort and increased reliability, an exit data set with a specific exit license plate string can be assigned to the correct entry data set with a specific entry license plate string, even if the respective vehicle license plate strings are not identical due to a license plate recognition error. An entry data set is a correct entry data set, in particular, if the exit data set originates from the same vehicle as the entry data set. This makes it possible to determine with sufficient certainty a correspondence between two (entry and exit) license plate strings with little effort if an incorrectly determined license plate string is detected.

In particular, the aim of the invention is to assign an entry data set and an exit data set to the same vehicle that generated the aforementioned data sets, for example, in order to determine the parking duration of the aforementioned vehicle. According to the invention, it has been recognized, in particular, that the raw signals transmitted by transmitting sources respectively signal sources located in or at a first vehicle are similar or at least largely identical during driving in and during driving out. Furthermore, these raw signals differ, in particular, regularly from the raw signals transmitted by signal sources located in or at a second vehicle. In particular, the number of transmitting sources (e.g., number of mobile terminal devices in a vehicle (e.g., 0-5), number of wheel sensors (e.g., 0-4) of the vehicle, vehicle control device (e.g., 0-1) of the vehicle, entertainment system (e.g., 0-1) of the vehicle, on-board computer (e.g., 0-1) of the vehicle, Car-2-X interface (e.g., 0-1) etc.) and/or the signal source types (e.g., (different) mobile devices, wheel sensor types of the vehicle, vehicle control device types of the vehicle, entertainment system types of the vehicle, on-board computer types of the vehicle, etc.) from vehicle to vehicle, but remain essentially the same for the same vehicle during driving in and driving out. It is preferably proposed to detect the respective raw signals when vehicles driving in and driving out and to use these preferably when necessary if it is not possible (with sufficient certainty) to uniquely assign an entry data set and an exit data set to each other (only) on the basis of the respective determined license plate strings.

The (central) data processing device can be formed by one or more computers and comprise at least one processor. The at least one processor (together with memory means and the like) can be configured to execute software modules (e.g., receiving module, evaluation module, etc.). For example, the data processing device can be formed by at least one local computer arranged at the parking device of the parking system and/or at least one background system arranged remotely from the parking device. The background system can preferably be formed by one or more (distributed) computers (e.g., servers) and/or a cloud system.

The data processing device is intended for use in a parking system and can, in particular, form and/or comprise the parking system controller. The parking system can comprise at least one parking device for parking vehicles respectively cars, such as a parking lot, a parking garage, and/or the like. A parking device can comprise a plurality of parking spaces. A vehicle can drive into the parking device via an entry of the parking device with an entry area. A vehicle can drive out of the parking device via an exit of the parking device with an exit area.

The entry and/or exit may be structurally separate, for example, with separate lanes for entry and exit and separate vehicle access devices, or they may be combined, for example, with an entry and exit with a shared lane and a shared vehicle access device. Furthermore, at the entry and/or exit, several lanes may be located next to each other in one direction, in particular, with and without structural separation of the lanes.

The parking system comprises at least one first license plate recognition equipment and at least one second license plate recognition equipment. Preferably, a respective license plate recognition equipment can be an LPR equipment. A license plate recognition equipment comprises one or more cameras. In the case of the at least one first license plate recognition equipment, the at least one camera can be arranged in or at the entry. In the case of the at least one second license plate recognition equipment, the at least one camera may be arranged in or at the exit. The respective camera may be positioned in such a way that image data from the license plates of the respective passing vehicles can be detected, i.e., the respective vehicles must pass through the respective detection field of the respective camera.

A license plate recognition equipment may comprise at least one image evaluation module. For example, each license plate recognition equipment may have a respective image evaluation module, or two or more license plate recognition equipment may share a common image evaluation module. For example, the data processing device may comprise the at least one image evaluation module.

The image evaluation module is, in particular, configured to determine a license plate string from the image data respectively image sequences provided by a camera. Preferably, the image detected by the camera containing the vehicle license plate can be evaluated by the image evaluation module, in particular, by means of OCR (optical character recognition), in order to determine the license plate string. Ideally, the license plate string is the character string that corresponds to the license plate string on the license plate attached to the vehicle and shown in the detected image data.

Furthermore, the parking system comprises at least one entry signal detection equipment and at least one exit signal detection equipment. An entry signal detection equipment can be arranged at an entry and an exit signal detection equipment can be arranged at an exit.

A respective signal detection equipment may comprise at least one receiver. The receiver is configured, in particular, to receive electromagnetic signals. In particular, the at least one receiver may cover the entry area (respectively the exit area) with a detection field respectively a detection range. A signal emitted by a transmitting device respectively signal source which is located in the entry area and/or the exit area is (always) received by the at least one receiver (and recorded, in particular, by a recording module of the respective signal detection equipment).

In particular, an entry signal detection equipment is provided for receiving at least one raw entry signal determined from predictable signals emitted by transmitting sources located in the entry area (at least during the driving in of a vehicle). Furthermore, an exit signal detection equipment is provided for receiving at least one raw exit signal determined from expected signals emitted by transmitting sources located in the exit area (at least during the driving out of a vehicle). It shall be understood that, in practice, the transmitting sources must transmit signals with a defined minimum transmission strength respectively must have a sufficient transmission range to be receivable by the respective signal detection equipment. Only these can be considered as receivable signal sources.

Furthermore, in practice, the entry signal detection equipment and exit signal detection equipment may be configured to detect, in particular, those types of raw signals that are determined from signals whose transmission is to be expected in accordance with the standard equipment of vehicles and vehicle occupants. These comprise, for example, signals from mobile devices (smartphones) of vehicle occupants, from wheel sensors of the vehicle, from vehicle control devices, from vehicle entertainment systems, from the vehicle's on-board computer, and from Car-2-X interfaces of the vehicle. In contrast, signals from CB radio devices or similar are not expected because only a few vehicles carry a corresponding transmitting source, and the entry signal detection equipment respectively exit signal detection equipment can be configured to not detect such signals. Furthermore, it shall be understood that the exit signal detection equipment is configured to detect types of raw signals from at least one signal source that represent a subset of the types of raw signals detected by the entry signal detection equipment. For example: If the entry signal detection equipment detects raw signals based on Bluetooth and WLAN signals from transmitting sources such as mobile devices and Car-2-X interfaces, then the exit signal detection equipment detects at least raw signals based on Bluetooth and/or WLAN signals from transmitting sources such as mobile devices and/or Car-2-X interfaces.

Preferably, the camera detection range of a camera can overlap at least partially with a detection field of a receiver, for example, essentially overlap.

Preferably, a respective specific license plate string (respectively the detected image data of the associated vehicle license plate) is linked to a license plate detection time. The license plate detection time indicates, in particular, the time at which the vehicle license plate was detected (in particular, the image data was recorded and/or the license plate string was determined).

Furthermore, a respective detected entry raw signal respectively a respective detected exit raw signal is preferably linked to a signal detection time. The signal detection time indicates, in particular, the point in time respectively the time range at which respectively during which the raw signal was received by a respective signal detection equipment.

Respective entry license plate strings and respective exit license plate strings, respectively, and respective entry raw signals and respective exit raw signals, respectively, can be assigned to each other by a data set generation module, for example, of the data processing device, on the basis of the respective detection times in order to form an entry data set and an exit data set, respectively. In other words, by assigning the respective entry license plate strings respectively respective exit license plate strings and respective entry raw signals respectively respective exit raw signals to each other in a time-synchronized manner, a respective entry data set respectively exit data set can be formed.

According to the invention, the at least one entry raw signal is detected during the driving in of the vehicle. This means, in particular, that the entry raw signals are detected in the entry area while the vehicle is in this entry area and the image data of the vehicle is recorded by the first license plate recognition equipment. In particular, only a single raw signal is detected if only one detected signal source is located in the entry area.

According to the invention, the at least one exit raw signal is detected during the driving out of the vehicle. This means, in particular, that the exit raw signals are detected in the exit area while the vehicle is in this exit area and the image data of the vehicle is recorded by the second license plate recognition equipment. In particular, only a single raw signal is detected if only one detected signal source is located in the exit area.

In particular, a respective data set can be generated as follows: preferably, only those entry raw signals can be stored with the determined entry license plate string in an entry data set which were detected in at least one defined time period (i.e., during the driving in of the vehicle) in the at least one detection field of the receiver of the entry signal detection equipment. The at least one defined time period may depend on: the opening time of a blocking element (e.g., barrier arm) of a vehicle access control device and/or the detection time of the vehicle license plate. The time periods may be selected depending on the spatial arrangement and/or distance of the blocking element, camera, and/or detection fields.

For example, data from first signals that were detected in the x (e.g., 1-5) seconds before a blocking element opens in at least one detection field in front of the blocking element, and preferably the same data from second signals that were detected in the x (e.g., 1-5) seconds after the opening of the blocking element in the at least one detection field behind the blocking element, can be taken into account to form a raw entry signal. The raw entry signal can thus be formed from an intersection of the data detected in the first signal (in front of the blocking element) and the data detected in the second signal (behind the blocking element). In particular, the entry raw signal can be formed from the largest intersection of the data detected in the first signal (in front of the blocking element) and the data detected in the second signal (behind the blocking element). This ensures, in particular, that the data in the entry raw signal originates from data sources that are actually located in or at the vehicle driving in. For example, a first detection area in front of the blocking element and a second detection area behind the blocking element can be provided, which form the entry area and are covered by at least one receiver, preferably at least two receivers. In this case, the vehicle (with the at least one transmitting source) can be located in the first detection area in front of the blocking element before the blocking element is opened and in the second detection area behind the blocking element after the blocking element is opened. Raw signals from other vehicles, which are, for example, waiting in an entry queue, are thus not assigned to the entry data set of this vehicle. This improves the assignment of raw signals to a vehicle license plate at the entry.

An intersection of data from at least one first detected (radio) signal and data from at least one second detected (radio) signal represents, for example, a character string that is encoded in both the first and second signals. The character string can be understood as a sequence of bits (ones and zeros) or as a sequence of bytes (i.e., 8-bit groups, which in turn represent letters, numbers, and symbols) or as a sequence of symbols represented in some other way. It is essential for the invention that the data processing device does not need to evaluate the data content of the signals, i.e., it does not need to know the actual information to be transmitted by the detected first and second signals. The only characteristic feature of the intersection is the match of a character string that occurs in the first signal and the second signal. The size of the intersection corresponds to the length of the character string that matches in the first signal and the second signal; the size of the intersection therefore corresponds to the number of characters that occur in identical order in the first signal and the second signal. The largest intersection is accordingly the longest character string that occurs identically in the first signal and the second signal. It shall be understood that the intersection can be formed from several matching character strings.

In a further embodiment, a first detection area may be provided in front of the blocking element and covered by a first receiver with a first detection field, and a second detection area may be provided behind the blocking element and covered by a second receiver with a second detection field, wherein the first detection field and the second detection field do not substantially overlap each other. For this purpose, the first receiver and the second receiver may be aligned accordingly and/or shielded from each other.

At an exit, the raw signals can be detected, in particular, in front of a blocking element, but otherwise in the same way as described above so that reference is made to the previous explanations.

At a vehicle access device without a blocking element, the detecting of the raw signals may depend, in particular, on the respective detection time of the respective vehicle license plate and the license plate string, respectively.

Optionally, for example, in addition to the opening process of the blocking element, the occupancy of a ground loop, which may be installed in the ground of the entry area, in particular, in front of a blocking element, may also be analyzed. This makes it possible to determine whether a vehicle has (with a high degree of probability) passed through the blocking element after it was opened and before it was closed.

As described, the parking system, in particular, the data processing device, may comprise at least one data set generation module. The receiving module may receive respectively obtain the at least one entry data set and/or the at least one exit data set from the data set generation module.

The received entry data sets are stored by a storage module in a data memory, in particular, in a database of the data processing device. Optionally, the received exit data sets can also be stored by the storage module in the data memory.

The data processing device comprises at least one evaluation module. The evaluation module can access the data memory. The evaluation module is, in particular, configured to assign a (received) exit data set to the corresponding (stored) entry data set. A respective assignment can be performed, in particular, (immediately) before a vehicle is released to drive out. The assignment is performed, in particular, if the evaluation module determines that there is a (unique) correspondence between a received exit data set and a stored entry data set.

In order to assign respectively determine a (sufficient) correspondence, the evaluation module is configured according to the invention to compare, in a first comparison step, the exit license plate string of the (received) exit data set with the respective entry license plate strings of the stored entry data sets. In particular, the comparing may comprise determining whether the exit license plate string of the (received) exit data set is identical to an entry license plate string of the stored entry data sets. It shall be understood that only one entry data set can be stored.

According to the invention, the evaluation module is configured to perform a second comparison step at least if, in the first comparison step, no entry license plate string can be identified in the stored entry data sets that is identical to the entry license plate string of the received exit data set. In the second comparison step, the evaluation module compares the at least one exit raw signal (preferably all exit raw signals) of the (received) exit data set with at least the at least one entry raw signal (preferably all entry raw signals) from the entry data set which contains the entry license plate string with the highest similarity respectively highest match with the exit license plate string of the exit data set. In variants of the invention, a plurality of second comparison steps may also be performed, for example, with the x (e.g., with x between 2 and 5) most similar vehicle identification strings.

In particular, the evaluation module can be configured to determine a similarity factor between the exit license plate string of the exit data set and the respective entry license plate string of the stored entry data sets in an intermediate step, which can take place, in particular, between the first comparison step and the second comparison step. Based on this intermediate step, at least the entry data set whose license plate has the highest similarity respectively match with the license plate of the exit data set can be determined. As described, multiple entry data sets (for example, x (e.g., with x between 2 and 5) most similar license plate) can also be determined in order to compare their respective entry raw signals in the second comparison step.

In the second comparison step, the at least one exit raw signal (in particular, all detected exit raw signals) is compared, by the evaluation module, with the at least one entry raw signal (in particular, all detected entry raw signals) of the (identified) entry data set. Comparing two respective raw signals means, in particular, that no comparison of the data content contained therein is made. The comparing of two raw signals can mean, in particular, determining the largest intersection of the data of both raw signals and, in particular, determining the size of the largest intersection. In particular, the similarity factor of two raw signals compared with each other can be the size of the largest intersection of the data of both raw signals. No data content evaluation is performed in the second comparison step. According to the invention, an understanding of the content of the detected raw signals is not necessary. For example, no identifier of a respective transmitting device is determined so that no identifiers are compared with each other.

According to a preferred embodiment of the data processing device according to the invention, the evaluation module can be configured to perform the second comparison step only if no entry license plate string identical to the exit license plate string was determined in the first comparison step. In other words, if in the first comparison step it is determined as the first positive comparison result that the exit license plate string of the exit data set is identical to an entry license plate string of the entry data set, the second comparison step can be omitted. This reduces computing time and/or computing power. It shall be understood that, in other variants of the invention, the second comparison step can also be performed if the first comparison result is positive, in particular, as an additional confirmation of the first positive comparison result. This further improves reliability.

According to a further preferred embodiment of the data processing device according to the invention, the evaluation module can be configured to compare, in the second comparison step, the at least one exit raw signal of the exit data set with the at least one entry raw signal of the entry data set of the stored entry data sets which contains the entry license plate string that is most similar to the exit license plate string of the exit data set, without extracting respectively determining the data content of the at least one raw exit signal and/or without extracting respectively determining the data content of the at least one raw entry signal. Consequently, no intelligence or knowledge is required in the data processing device to determine the data content (e.g., an identifier and/or the like). The implementation effort can be reduced even further.

As has already been described, the evaluation module is configured to determine an entry data set corresponding to the received exit data set from the stored entry data sets, in particular, in order to assign the corresponding data sets to each other respectively to link them with each other. According to a further embodiment of the data processing device according to the invention, the evaluation module can be configured to determine an entry data set corresponding to the received exit data set from the stored entry data sets if
in the first comparison step, it is determined that the entry license plate string of the corresponding entry data set is identical to the exit license plate string of the received exit data set, or
in the second comparison step, it is determined that the entry raw signal of the corresponding entry data set and the exit raw signal of the received exit data set satisfy a matching criterion.

If it is determined in the first comparison step that the exit license plate string of the exit data set is the same as an entry license plate string of a first entry data set, this exit data set is assigned to this first entry data set. In this case, the entry data set and the exit data set correspond (uniquely) to each other and are linked to each other.

An assignment and link, respectively, can also be performed if no identity is determined between the exit license plate string and one of the entry license plate strings in the first comparison step, provided that the at least one entry raw signal of the entry data set matches the entry license plate string that is most similar to the exit license plate string of the exit data set, and the at least one exit raw signal of the exit data set fulfills the at least one matching criterion.

The matching criterion specifies, in particular, if there is sufficient matching between the at least one entry raw signal and the at least one exit raw signal so that it is (sufficiently) certain that the entry data set and the exit data set originate from the same vehicle. In one embodiment, the matching criterion may be predefined. For example, the matching criterion may be a threshold value that specifies if an entry raw signal of an entry data set and an exit raw signal of an exit data set are to be evaluated as matching.

The comparing of the at least one entry raw signal with the at least one exit raw signal in the second comparison step may, in particular, comprise determining the matching signal parts (e.g., a (pure) comparison of the respective bit streams) of said raw signals. In particular, it has been recognized that parts of the payload transmitted by a signal source may change at least partially over time, i.e., in particular, between the entry time and the exit time. As already described, the matching criterion can determine if the raw signals mentioned above are sufficiently similar to establish that the entry data set and the exit data set originate from the same vehicle. In a particularly reliable and simple manner, the entry data set and the exit data set can also be assigned to each other without identical vehicle license plate strings.

According to one embodiment, when comparing a stored entry raw signal with the exit raw signal, the respective matching criterion can be the size of the intersection of the data of the respective entry raw signal and the exit raw signal. When comparing the exit raw signal with the stored entry raw signals, the entry raw signal that provides the largest intersection has the best matching criterion, and the associated entry data set can be determined as corresponding to the exit data set. According to this further embodiment of the data processing device according to the invention, the evaluation module can be configured to determine an entry data set corresponding to the received exit data set from the stored entry data sets by:
continuously comparing, in a first comparison step, the exit license plate string of the exit data set with the respective entry license plate strings of the stored entry data sets and determining the corresponding entry data set, as well as terminating the first comparison step as soon as a stored entry license plate string is found that is identical to the exit license plate string, or if no entry license plate string identical to the exit license plate string can be determined from all stored entry license plate strings, and/or
at least if no entry license plate string identical to the exit license plate string was determined in the first comparison step: comparing, in a second comparison step, the at least one exit raw signal of the exit data set with the at least one entry raw signal of the at least one entry data set, preferably the at least two entry data sets, of the stored entry data sets which contain the entry license plate strings that are most similar to the exit license plate string of the exit data set, determining in each case an intersection of the respective input raw signals of the at least one input data set, preferably of the at least two input data sets, with the output raw signal and identifying the corresponding input data set on the basis of the determined largest intersection.

According to a further preferred embodiment of the data processing device according to the invention, the evaluation module can be configured to determine (e.g., in the aforementioned intermediate step) a similarity factor between two (in particular non-identical) license plate strings compared in the first comparison step, based on measuring a Levenshtein distance between the compared license plate strings. B measuring the Levenshtein distance it is, in particular, determined the minimum number of changes necessary to match two character strings. The evaluation module can be configured at least to determine the character strings that are most similar based on the (respectively) determined similarity factors. In other words, the two compared character strings with the lowest Levenshtein distance can be determined by the evaluation module as being the most similar. In a corresponding manner, the next most similar character strings or their respective data sets can be determined in variants of the invention. The similarity of character strings respectively entry data set and exit data set can be determined in a simple manner.

According to a further preferred embodiment of the data processing device according to the invention, the evaluation module can be configured to dynamically determine the matching criterion based at least on the similarity factor of the license plate strings that are most similar. In particular, the matching criterion can be determined according to the following rule. The more dissimilar the vehicle license plates are (for example, the greater the Levenshtein distance), the higher the match between the at least one entry raw signal of the corresponding entry data set and the at least one exit raw signal of the corresponding exit data set must be. Even with larger deviations between the vehicle license plates, this enables the mentioned data sets to be assigned in a reliable manner. The rate of successful (and correct) assignments can be increased even further.

As has already been described, according to a preferred embodiment of the data processing device according to the invention, the entry data set may contain a plurality of detected raw entry signals transmitted by a corresponding plurality of transmitting devices (respectively signal sources). Alternatively or additionally, the exit data set may contain a plurality of detected exit raw signals transmitted by a corresponding plurality of transmitting devices.

According to a further preferred embodiment of the data processing device according to the invention, a transmitting device (in particular, the plurality of transmitting devices) can be selected from the group comprising:
mobile terminal,
wheel sensor of the vehicle,
vehicle control unit of the vehicle,
vehicle entertainment system,
on-board computer of the vehicle
Car-2-X interface of the vehicle.

In particular, it has been recognized that the aforementioned transmitting sources emit raw signals that are capable of distinguishing a first vehicle from a second vehicle, for example, based on the different number and/or type of signals. The raw signals can be, for example, Bluetooth, WLAN, IEEE 802.11p, Cellular-V2X (or 3GPP), mobile communications, ISM (Industrial, Scientific and Medical) radio band, etc. For example, a wheel sensor regularly transmits sensor data about the tire (e.g., pressure, temperature, etc.). A vehicle control device also transmits control signals at regular intervals. Entertainment systems and on-board computers are also signal sources whose raw signals can be detected by a signal detection equipment. It has been recognized that the sum of the raw signals transmitted and emitted, respectively, by a vehicle characterizes the vehicle and, in particular, distinguishes it from other vehicles. In particular, the evaluation of the detected license plate strings and the raw signals respectively detected by the signal detection equipment together enables the assignment of (correct) entry data sets and exit data set with a (high) rate of, in particular, over 99 %, as tests have shown.

Preferably, the entry raw signals and/or the exit raw signals can be at least partially advertisement signals.

According to a further embodiment of the data processing device according to the invention, the data processing device may comprise at least one release module. The release module may be configured to release a vehicle access device (with and without a blocking element) arranged in the exit area at least based on the evaluation result of the evaluation module. Based on the evaluation result means, in particular, that the aforementioned vehicle access device is (only) released for a driving through of the vehicle if the exit data set of the vehicle can be assigned to an entry data set. Furthermore, based on the evaluation result means, in particular, that the aforementioned vehicle access device is then blocked (respectively remains blocked) for a driving through of the vehicle if the exit data set of the vehicle cannot be assigned to an entry data set. For example, when access is granted, an actuator can be activated to move the blocking element in order to open (or close) it and/or a light signal device (e.g., a traffic light) can be activated to indicate that access has been granted by means of a light signal.

Alternatively or additionally, the entry data set may contain an entry time point of the vehicle. The data processing device may further comprise a parking duration determination module. The parking duration determination module may be configured to determine the parking duration of the vehicle based on the entry time of the vehicle and a provided exit time of the vehicle. For example, the exit time can be the license plate determination time of the exit data set. For example, the billing of the parking process can be carried out (in a known manner) depending on the determined parking duration.

According to a further embodiment of the data processing device according to the invention, the data processing device may further comprise at least one user database. The user database, for example, implemented in a data memory of the data processing device, may be configured to store user data sets each containing at least one user identifier, a vehicle license plate, in particular, the actual vehicle license plate from a registration process of a user, and at least one data field for storing raw signal data sets (with at least one raw signal, such as an entry raw signal and/or exit raw signal). The user identifier can, in particular, uniquely identify the user (of the vehicle with the vehicle license plate of the user data set). A user data set may contain at least one further datum, such as billing datum (e.g., account data, credit card data, etc.) for billing parking transactions, address data of the user, parking attributes of the user (e.g., long-term parkers, etc.) and/or the like.

The data processing device may comprise at least one update module. The update module may be configured to add the at least one entry raw signal from a received entry data set to the user data set whose license plate string is identical to the entry license plate string from the received entry data set, and/or for adding the at least one exit raw signal from a received exit data set to the user data set whose license plate string is identical to the exit license plate string from the received exit data set. In particular, the update module can be configured to determine a user data set on the basis of a vehicle license plate string detected and, in particular, determined during driving in or driving out.

In variants of the invention, stored entry raw signals and/or exit raw signals can be deleted from the user data set depending on at least one predetermined condition, for example, after a certain period of time has elapsed or if a maximum permissible number of entry raw signals and/or exit raw signals has been reached.

According to a further embodiment of the data processing device according to the invention, the evaluation module can be configured to determine a user data set corresponding to the received exit data set from the stored entry data sets by:
comparing, in a third comparison step, the exit license plate string of the exit data set with the respective vehicle license plates of the stored user data sets, and
comparing, in a fourth comparison step, (only) the at least one exit raw signal of the exit data set with the at least one raw signal data set of the user data set of the stored user data sets that contains the vehicle license plate that is most similar to the exit license plate string of the exit data set, at least if no vehicle license plate string identical to the exit license plate string was determined in the third comparison step.

The comparison in the third comparison step can be carried out in a manner analogous to the first comparison step so that the explanations relating to the first comparison step can be transferred to the third comparison step. Furthermore, the comparison in the fourth comparison step can be carried out in a manner analogous to the second comparison step so that the explanations relating to the second comparison step can be transferred to the fourth comparison step. Furthermore, a further intermediate step may be provided, which can be carried out in a manner analogous to the previously described intermediate step so that the explanations relating to the previously described intermediate step can be transferred to the further intermediate step. In an even more reliable manner, an exit data set can be assigned to a (correct) entry data set in a parking system.

According to a further embodiment of the data processing device according to the invention, the third comparison step can be carried out by continuously comparing, in a third comparison step, the exit license plate string of the exit data set with the respective vehicle license plates of the stored user data sets and terminating the third comparison step as soon as a vehicle license plate is found that is identical to the exit license plate string, or if no vehicle license plate string identical to the exit license plate string can be determined in the entirety of all stored user data sets.

According to a preferred embodiment of the parking system according to the invention, the parking system may comprise at least one (restricted) vehicle access device arranged at the entry to the parking device with at least one blocking element. Preferably, a barrier may be provided as the blocking element, for example, a barrier arm pivotably arranged on a column respectively a base of the vehicle access device. In variants of the invention, a roller door, swing door, sectional door, retractable bollard, or the like may be provided alternatively or additionally at the vehicle access device as a barrier element. The blocking element may, in particular, comprise a (controllable) actuator configured to move the blocking element between an open state and a closed state.

As has been already described, an entry signal detection equipment may comprise at least one (electromagnetic) receiver configured to detect raw signals originating from signal sources located at or in the vehicle located in the entry area. Preferably, the entry signal detection equipment may comprise at least one first receiver, which is configured to provide a first detection field in a direction of passage in front of the blocking element (e.g., in front of the barrier boom), and at least one second receiver, which is configured to provide a second detection field in the direction of passage behind the blocking element (e.g., behind the barrier boom). The two detection fields mentioned above may, in particular, form respectively cover the entry area.

As has already been described, the first license plate recognition equipment may comprise at least one camera arranged at the entry. The detection field of the camera and the first detection field may overlap at least partially.

Particularly preferrable an (electromagnetic) shield can be arranged between the first receiver and the second receiver.

Furthermore, the parking system, in particular, if it comprises the first receiver and the second receiver, may comprise a data set unification module, configured
to receive the entry license plate string determined by the first license plate recognition equipment of a vehicle driving into a parking device of the parking system,
to receive the at least one first entry raw signal detected by the first receiver in a first detection field during driving in of the vehicle in front of the blocking element,
to receive at least one second raw entry signal detected by the second receiver in a second detection field during the driving in of the vehicle behind the blocking element,
to generate the entry data set, containing as an entry license plate string the entry license plate string of the first entry data set and as an entry raw signal the intersection of the at least one detected first entry raw signal and the at least one detected second entry raw signal.

According to a preferred embodiment of the parking system according to the invention, the parking system may comprise at least one (restricted) vehicle access device arranged at the exit of the parking device with at least one blocking element. Preferably, a barrier may be provided as the blocking element, for example, a barrier arm pivotably arranged on a column respectively a base of the vehicle access device. In variants of the invention, a roller door, swing gate, sectional door, retractable bollard, or the like may be provided alternatively or additionally at the vehicle access device as a blocking element. The blocking element may, in particular, comprise a (controllable) actuator configured to move the blocking element between an open state and a closed state.

As has already been described, an exit signal detection equipment may comprise at least one (electromagnetic) receiver configured to detect raw signals originating from signal sources located on or in the vehicle located in the exit area. Preferably, the exit signal detection equipment may comprise at least one receiver configured to provide a further detection field in a direction of passage in front of the blocking element (e.g., in front of the barrier arm). The receiver may be a directional receiver. As has already been described, the second license plate recognition equipment may comprise at least one camera arranged at the exit. The detection field of the camera and the additional detection field may overlap at least partially.

According to a further (alternative) embodiment of the parking system according to the invention, the parking system may further comprise at least one (unrestricted) vehicle access device arranged at the entry of the parking device without a physical blocking element. The entry signal detection equipment may comprise at least one receiver configured to provide a third detection field. As has already been described, the first license plate recognition equipment may comprise at least one camera arranged at the entry. The detection field of the camera and the third detection field may overlap at least partially.

According to a further (alternative) embodiment of the parking system according to the invention, the parking system may further comprise at least one (unrestricted) vehicle access device arranged at the exit of the parking device without physical blocking element. The exit signal detection equipment may comprise at least one receiver configured to provide a fourth detection field. As has already been described, the second license plate recognition equipment may comprise at least one camera arranged at the exit. The detection field of the camera and the fourth detection field may overlap at least partially.

A further aspect of the invention is a method, in particular, a computer-implemented method. The method can be carried out, in particular, by the data processing device described above, in particular, in a parking system as described above. The method comprises:
receiving, by a receiving module of a data processing device of a parking system, an entry data set containing an entry license plate string of a vehicle driving into a parking device, determined by a first license plate recognition equipment, and at least one entry raw signal detected by an entry signal detection equipment in an entry area of the parking device during the driving in of the vehicle,
storing, by at least one storage module of the data processing device, the received entry data set in a data memory,
receiving, by the receiving module, of an exit data set containing an exit license plate string determined by a second license plate recognition equipment of a vehicle driving out of the parking device and at least one raw exit signal detected by an exit signal detection equipment in an exit area of the parking device during the driving out of the vehicle,
determining, by at least one evaluation module of the data processing device, an entry data set corresponding to the received exit data set from the stored entry data sets by:
comparing, in a first comparison step, the exit license plate string of the exit data set with the respective entry license plate strings of the stored entry data sets, and/or
comparing, in a second comparison step, (only) the at least one exit raw signal of the exit data set with the entry raw signal of the at least one entry data set of the stored entry data sets which contains the entry license plate string that is most similar to the exit license plate string of the exit data set, at least if no entry license plate string identical to the exit license plate string was determined in the first comparison step.

In a further embodiment of the method, the determining step comprises the comparison steps:
continuously comparing, in a first comparison step, the exit license plate string of the exit data set with the respective entry license plate strings of the stored entry data sets and determining the corresponding entry data set, as well as terminating the first comparison step as soon as a stored entry license plate string is found that is identical to the exit license plate string, or if no entry license plate string identical to the exit license plate string can be determined from all stored entry license plate strings, and/or
at least if no entry license plate string identical to the exit license plate string was determined in the first comparison step: comparing, in a second comparison step, the at least one exit raw signal of the exit data set with the at least one entry raw signal of the at least one entry data set, preferably the at least two entry data sets, of the stored entry data sets which contain the entry license plate strings that are most similar to the exit license plate string of the exit data set, determining in each case an intersection of the respective input raw signals of the at least one input data set, preferably of the at least two input data sets, with the output raw signal and identifying the corresponding input data set on the basis of the determined largest intersection.

A further aspect of the invention is a computer program comprising commands which, when executed by at least one processor of a (previously described) data processing device, cause the device to execute and/or control the previously described method.

The computer program, in particular the instructions or program commands, can be stored in a computer program product, in particular a program memory. For example, a program memory is a non-volatile memory such as a flash memory, a magnetic memory, an EEPROM memory (electrically erasable programmable read-only memory) and/or an optical memory.

In addition, a data processing device may have a main memory, for example a volatile or non-volatile memory, in particular a random access memory (RAM), such as a static RAM memory (SRAM), a dynamic RAM (DRAM), a ferroelectric RAM (FeRAM) and/or a magnetic RAM (MRAM). The at least one processor of the data processing device can, for example, store intermediate results or similar in the main memory.

The modules described above (e.g., receiving module, evaluation module, data set generation module, release module, parking duration determination module, billing module, update module, etc.) are preferably at least partially software elements (e.g., executable code) and can be executed by a processor of the data processing device. It should also be noted that terms such as “first,” “second,” etc. do not indicate an order, but are used in particular to distinguish between two elements (e.g., detection field, license plate recognition equipment, etc.).

The features of the data processing devices, parking systems, methods, and computer programs can be freely combined with one another. In particular, features of the description and/or the dependent claims, even with complete or partial circumvention of features of the independent claims, may be independently inventive when standing alone or freely combined with one another.

### BRIEF DESCRIPTION OF THE DRAWINGS

There are now a multitude of possibilities for designing and further developing the data processing device, the method, the computer program, and the parking system according to the invention. Reference is made in this regard to the patent claims subordinate to the independent patent claims on the one hand, and to the description of embodiments in conjunction with the drawing on the other. The drawing shows:

FIG. 1 shows a schematic view of an embodiment of a data processing device according to the invention,

FIG. 2 shows a schematic view of an embodiment of a parking system according to the invention with a further embodiment of a data processing device according to the invention,

FIG. 3 shows a diagram of an embodiment of a method according to the invention, and

FIG. 4 shows a schematic view of an embodiment of an entry data set and an exit data set according to the invention.

### DETAILED DESCRIPTION

Similar reference signs are used below for similar elements.

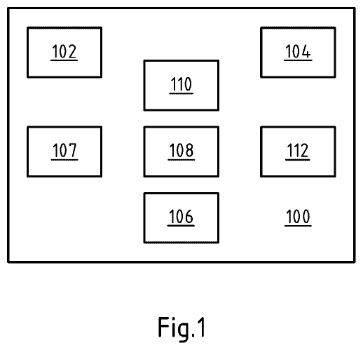

FIG. 1 shows a schematic view of an embodiment of a data processing device 100 according to the invention for a parking system. The data processing device 100 is, in particular, a component of the (not shown) parking system and serves to operate respectively control the parking system. The data processing device 100 can, for example, be formed by a local computer arranged at the parking device of the parking system and/or by a background system (e.g., a server and/or a cloud system) of the parking system arranged remotely from the parking device.

The data processing device 100 may comprise at least one processor 102 and a memory means 104, which are configured to execute software modules, for example, the modules 106, 108, 110 of the data processing device 100. It shall be understood that the data processing device 100 may comprise further hardware elements, such as input means, display means, etc., and/or software elements.

The data processing device 100 comprises at least one receiving module 106. The receiving module 106 is configured to receive an entry data set. In particular, the receiving module 106 receives respectively obtains a plurality of entry data sets. An entry data set refers to a driving in process of a vehicle into the parking device and is linked, in particular, to this vehicle, in particular, by means of the entry license plate string and/or the at least one detected entry raw signal, as will be explained in more detail below.

An entry data set contains at least one entry license plate string determined by a first license plate recognition equipment (of the parking system) based on a detected image of the vehicle driving into a parking device of the parking system, and at least one entry raw signal, in particular, a plurality of entry raw signals, detected by an entry signal detection equipment of the parking system in an entry area of the parking device during the driving in of the vehicle.

Preferably, an entry data set can comprise at least one further datum, such as the time of entry of the vehicle (e.g., time of detection of the vehicle license plate respectively of the entry license plate string, opening time of a barrier element, etc.), the (unique) identifier of the first license plate recognition equipment (in particular, the camera), the (unique) identifier of the entry signal detection equipment (in particular, the receiver), etc.

The data processing device 100 comprises at least one storage module 110. The storage module 110 is configured to store the received entry data set, in particular, each received entry data set, in a data memory 112. For example, the data processing device 100 may comprise the data memory 112.

The receiving module 106 (which may be formed from a plurality of receiver elements) is further configured to receive respectively obtain an exit data set. In particular, the receiving module 106 receives a plurality of exit data sets. An exit data set relates to a driving out process of a vehicle from the parking device and is linked, in particular, to this vehicle, in particular, by means of the vehicle license plate string of the vehicle and/or the at least one detected exit raw signal, as will be explained in more detail below.

The exit data set contains at least one exit license plate string determined by a second license plate recognition equipment based on a detected image of a vehicle driving out of the parking device of the parking system, and at least one raw exit signal, in particular, a plurality of raw exit signals, detected by an exit signal detection equipment of the parking system in an exit area of the parking device during the driving out of the vehicle.

Preferably, an exit data set can comprise at least one further piece of data, such as the exit time of the vehicle (e.g., time of detection of the vehicle license plate), the (unique) identifier of the second license plate recognition equipment (in particular, the camera), the (unique) identifier of the exit signal detection equipment (in particular, the receiver), etc.

According to the invention, the data processing device 100 comprises at least one evaluation module 108. The evaluation module 108 is configured to determine an entry data set corresponding to the received exit data set from the stored entry data sets by:
comparing, in a first comparison step, the exit license plate string of the exit data set with the respective entry license plate strings of the stored entry data sets, and
comparing, in a second comparison step, (only) the at least one exit raw signal of the exit data set with the entry raw signal of the at least one entry data set of the stored entry data sets which contains the entry license plate string that is most similar to the exit license plate string of the exit data set, at least if no entry license plate string was determined to be identical to the exit license plate string in the first comparison step.

The evaluation module 108 is, in particular, configured to perform the second comparison step only if no entry license plate string identical to the exit license plate string was determined in the first comparison step.

Optionally, the data processing device 100, in particular, if the parking system comprises a first receiver and a second receiver, may comprise a data set unification module 107, which may be configured
to receive the entry license plate string determined by the first license plate recognition equipment of a vehicle driving into a parking device of the parking system,
to receive the at least one first entry raw signal detected by the first receiver in a first detection field during driving in of the vehicle in front of the blocking element,
to receive at least one second raw entry signal detected by the second receiver in a second detection field during the driving in of the vehicle behind the blocking element, and
to generate the entry data set, containing as an entry license plate string the entry license plate string of the first entry data set and as an entry raw signal the intersection of the at least one detected first entry raw signal and the at least one detected second entry raw signal.

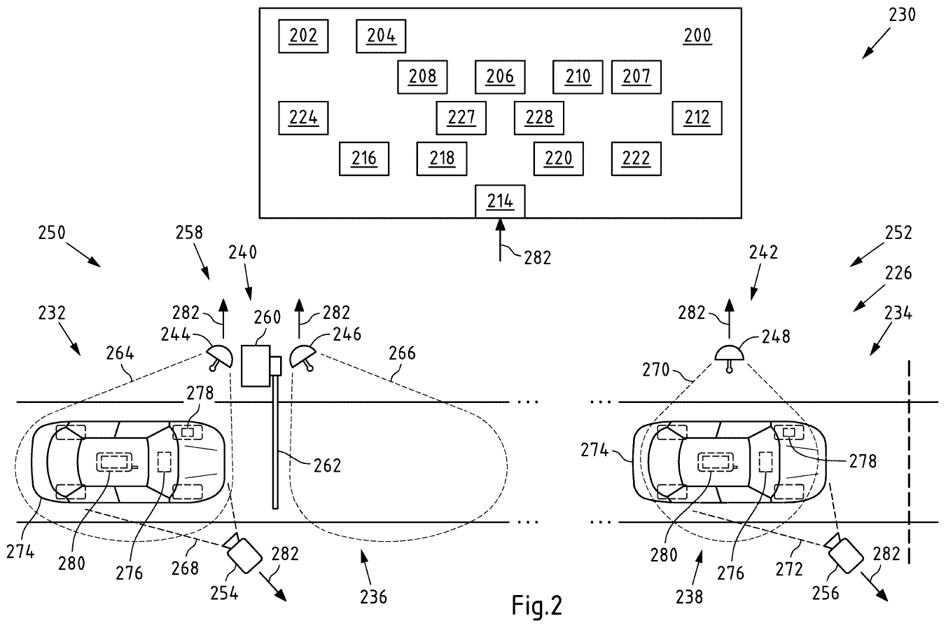

FIG. 2 shows a schematic view of an embodiment of a parking system 230 according to the invention with a further embodiment of a data processing device 200 according to the invention. In order to avoid repetitions, the differences from the previous embodiment are essentially described below and reference is otherwise made to the explanations relating to FIG. 1.

The parking system 230 comprises, in particular, a parking device, which is not shown in FIG. 2 for the sake of clarity. The parking device, such as a parking lot, a parking garage, etc., serves to enable users to (temporarily) park their vehicles in a parking space of the parking device. A corresponding process is referred to, in particular, as a parking process.

Preferably, at least one entry 232 and at least one exit 234 can be provided. A vehicle 274 can drive into the parking device via the at least one entry 232 (of the parking device). Furthermore, a vehicle 274 can drive out of the parking device via the at least one exit 234 (of the parking device).

Preferably, the parking system 230 can comprise a (restricted) vehicle access device 258 with a blocking element 260, 262 arranged at the entry 232. In the present embodiment, a barrier boom 262 movable at a base 260 between an open position and a closed position is provided as an example of blocking element 260, 262. It shall be understood that in variants of the invention other blocking elements may be provided or a vehicle access device without (physical) blocking element.

The parking system 230 may also comprise an (unrestricted) vehicle access device 226 at the exit 234 without a (physical) blocking element. It shall be understood that in variants of the invention a vehicle access device with blocking element may be provided.

In addition to the at least one data processing device 200, the parking system 230 comprises at least one first license plate recognition equipment 250 which is arranged at the entry 232 and which is configured to determine an entry license plate string of a vehicle 274 driving into a parking device. The first license plate recognition equipment 250 comprises at least one camera 254. The camera 254 may be arranged at the entry 232. In particular, the camera 254 can be arranged at the entry 232 in such a way that the license plate of a vehicle 274 passing through the entry area 236 (e.g., in front of the blocking element 260, 262) passes through the detection area 268 of the camera, in particular, must always pass through it.

The first license plate recognition equipment 250 may further comprise at least one image evaluation module 216. For example, the image evaluation module 216 may be implemented as a software module executable by processor 202 and storage means 204 of the data processing device 200. By means of a (wireless and/or wired) data communication network 282, image data detected by the camera 254 can be transmitted to a communication module 214 of the data processing device 200 and, in particular, made available to the image evaluation module 216.

The first license plate recognition equipment 250 may, in particular, be an LPR license plate recognition equipment. With an LPR license plate recognition equipment, the image of the vehicle license plate detected by the camera 254 is evaluated by the image evaluation module 216, in particular, by means of OCR (optical character recognition), in order to determine the license plate string.

It shall be understood that, in particular, in the case of an entry with a plurality of lanes, a corresponding plurality of cameras may be provided.

The parking system 230 comprises at least one second license plate recognition equipment 252, which is configured to determine an exit license plate string of a vehicle 274 driving out of the parking device. The second license plate recognition equipment 252 comprises at least one camera 256. The camera 256 can be arranged at the exit 234. In particular, the camera 256 can be arranged at the exit 234 in such a way that the license plate of a vehicle 274 driving out in an exit area 238 passes through the detection area 272 of the camera 256, in particular, must always pass through it.

The second license plate recognition equipment 252 may further comprise at least one image evaluation module 216. For example, the image evaluation module 216 (as a software module executable by processor 202 and storage means 204) can be implemented in the data processing device 200. In particular, the first and second license plate recognition equipment pieces 250, 252 can share a common image evaluation module 216.

By means of the data communication network 282, image data detected by the camera 256 can be transmitted to the communication module 214 of the data processing device 200 and, in particular, made available to the image evaluation module 216. The second license plate recognition equipment 252 can, in particular, be an LPR license plate recognition equipment, like the first license plate recognition equipment.

According to the invention, the parking system 230 comprises at least one entry signal detection equipment 240. The entry signal detection equipment 240 comprises at least one (electromagnetic) receiver 244, 246. The entry signal detection equipment 240 is configured to detect at least one raw entry signal in the entry area 236 during the driving in of the vehicle 274.

The at least one receiver 244, 246 preferably provides at least one detection field 264, 266. The at least one detection field 264, 266 can, in particular, form respectively cover the entry area 236. The entry signal detection equipment 240 is configured, in particular, to detect at least one expected raw signal emitted by signal sources 276, 278, 280 located in the entry area 236 respectively the at least one detection field 264, 266. In particular, it can be assumed that the detected at least one raw signal originates from signal sources 276, 278, 280 located in and/or at the vehicle 274, such as a mobile terminal device 276 of a user of the vehicle 274, a wheel sensor 278 of the vehicle 274 and/or an entertainment system 280 and/or a Car-2-X interface of the vehicle 274. It shall be understood that in other variants of the invention more or fewer signal sources may be present.

In the present embodiment, two receivers 244, 246 are provided as examples. Preferably, the first receiver 244 can be configured to provide a first detection field 264 in a direction of passage (as seen) in front of the blocking element 262 (e.g., in front of the barrier boom) and the second receiver 246 can be configured to provide a second detection field 266 in the direction of passage (as seen) behind the blocking element 262 (e.g., behind the barrier boom). The receivers 244, 246 may be directional receivers, for example, with a (not shown) shield between the receivers 244, 246. For example, data from first signals of the first receiver 244, which were detected in the first detection field 264 in front of the blocking element 262, and data from second signals of the second receiver 246, which were detected in the second detection field 266 behind the blocking element 262, can now be taken into account to form a raw entry signal. The raw entry signal can thus be formed from an intersection of the data detected in the first signal (before the blocking element 262) and the data detected in the second signal (after the blocking element 262). In particular, the raw entry signal can be formed from the largest intersection of the data detected in the first signal (before the blocking element 262) and the data detected in the second signal (after the blocking element 262). This ensures, in particular, that the data in the raw entry signal originates from data sources that are actually located in or on the vehicle driving in.

The detection range 268 of the camera 254 and the at least one detection field 264, 266 may overlap at least partially.

In particular, the image data of a vehicle 274 and the raw entry signals originating from this vehicle 274 can be detected in a time-synchronized manner, i.e., in particular, during the driving in of the vehicle 274. Preferably, the detected image data and the detected raw entry signals can each be provided with detection times. The entry license plate strings determined from the image data and the detected entry raw signals can then be assigned to each other on the basis of the detection times in order to form, in particular, the entry data set (for vehicle 274). For example, the data processing device 200 may comprise a data set generation module 218 (executable by processor 202 and storage means 204) configured to generate the entry data sets. These can be provided to the receiving module 206 and stored by the storage module 210 in the data memory 212.

In addition, the parking system 230 comprises at least one exit signal detection equipment 242, which is configured to detect at least one raw exit signal in the exit area 238 of the parking device while the vehicle 274 is driving out.

The exit signal detection equipment 242 comprises at least one (electromagnetic) receiver 248. The at least one receiver 248 preferably provides at least one detection field 270. The at least one detection field 270 can, in particular, form respectively cover the exit area 238. The exit signal detection equipment 242 is configured, in particular, to detect at least one expected raw signal emitted by signal sources 276, 278, 280 located in the exit area 238 respectively the at least one detection field 270. In particular, it can be assumed that the detected at least one raw signal originates from signal sources 276, 278, 280 located in and/or at the vehicle 274, such as a mobile terminal 276 of a user of the vehicle 274, a wheel sensor 278 of the vehicle 274, or a wheel sensor 280 of the vehicle 274 and/or an entertainment system 280 of the vehicle 274 and/or a Car-2 interface of the vehicle. It shall be understood that in other variants of the invention more or fewer transmitting sources may be present.

In the present case, a (directional) receiver 248 is provided as an example. The detection range 272 of the camera 256 and the at least one detection field 270 may overlap at least partially.

In particular, the image data of a vehicle 274 and the raw exit signals originating from this vehicle 274 can be detected in a time-synchronized manner, i.e., in particular, during the driving out of the vehicle 274. Preferably, the detected image data and the detected raw entry signals can each be provided with detection times. The exit license plate strings determined from the image data and the detected exit raw signals can then be assigned to each other on the basis of the detection times in order to form, in particular, the exit data set (for vehicle 274). For example, the data processing device 200 may comprise a data set generation module 218 (executable by processor 202 and storage means 204) configured to generate the exit data sets. These can be provided to the receiving module 206 and evaluated by the evaluation module 208.

Furthermore, the data processing device 200 optionally comprises at least one release module 220 (executable by processor 202 and storage means 204), which is configured to release a vehicle access device arranged in the exit area 238 at least based on the evaluation result of the evaluation module 208. For example, a (not shown) light signal device (e.g., a traffic light) can be controlled by the release module 220 based on the evaluation result. In other variants of the invention, in which a vehicle access device with a blocking element is provided at the exit, a controlling, by the release module, of the actuator of the blocking element can be performed.

As has already described, the entry data set may contain an entry time point of the vehicle 274. The data processing device 200 can optionally comprise a parking duration determination module 222 (executable by processor 202 and storage means 204) configured to determine the parking duration of vehicle 274 based on the entry time point of the vehicle and a provided (for example, by the exit data set) exit time point of the vehicle 274. Optionally, a billing module 224 (executable by processor 202 and storage means 204) may be provided, which is configured to bill the parking process based on the determined parking duration of the vehicle 274 (and, in particular, in a known manner).

Furthermore, the data processing device 200 may comprise at least one optional user database 227 configured to store user data sets, each containing at least one user identifier, a vehicle license plate, in particular, the true vehicle license plate from a registration process of a user, and at least one data field for storing raw signal data sets. The data processing device 200 may comprise at least one optional update module 228 (executable by processor 202 and storage means 204) configured to add the at least one detected entry raw signal and/or the at least one detected exit raw signal to the raw signal data set.

The evaluation module 208 may be optionally configured to determine a user data set corresponding to the received exit data set from the stored entry data sets by:
comparing, in a third comparison step, the exit license plate string of the exit data set with the respective vehicle license plates of the stored user data sets, and
comparing, in a fourth comparison step, (only) the at least one exit raw signal of the exit data set with the at least one raw signal data set of the user data set of the stored user data sets that contains the vehicle license plate that is most similar to the exit license plate string of the exit data set, at least if no vehicle license plate string identical to the exit license plate string was determined in the third comparison step.

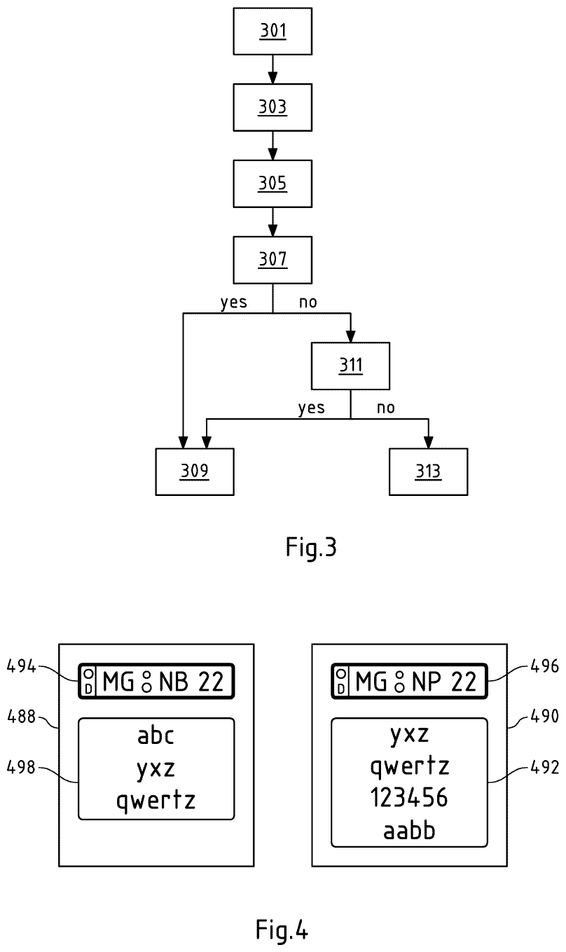

The functioning of the data processing device 100, 200, for example, according to FIGS. 1 and/or 2, and, in particular, the operation of the parking system 230 according to FIG. 2, is described in more detail by means of FIGS. 3 and 4.

FIG. 3 shows a diagram of an embodiment of a preferred method according to the invention. FIG. 4 shows a schematic view of an embodiment of an entry data set 488 and an exit data set 490 according to the invention.

The entry data set 488 contains an entry license plate string 494 of the vehicle driving into the parking device of the parking system, determined by the first license plate recognition equipment, and at least one entry raw signal 498 detected by an entry signal detection equipment in an entry area of the parking device during the driving in of the vehicle. In the present example, three entry raw signals were detected. As described, at least one additional datum may be present in other variants of the invention.

The exit data set 490 contains an exit license plate string 496 determined by the second license plate recognition equipment for the vehicle driving out of the parking device and at least one raw exit signal 492 detected by an exit signal detection equipment in the exit area of the parking device during the driving out of the vehicle. In the present example, four exit raw signals were detected.

Furthermore, it can be seen from the example in FIG. 4 that instead of “NB” in the entry license plate string 494 of the entry data set 488, “NP” was determined in the exit license plate string 496 for the exit data set 490. In the prior art, this would lead to an error, as no assignment between the entry data set 488 and the exit data set 490 would take place. According to the invention, a (reliable) assignment of data sets 488 and 490 to each other takes place, as explained in more detail in FIG. 3.

In a first step 301, a receiving is performed, by the receiving module of the data processing device, of an entry data set 488 containing an entry license plate string determined by a first license plate recognition equipment of a vehicle driving into a parking device and at least one entry raw signal detected by an entry signal detection equipment in an entry area of the parking device during the driving in of the vehicle, as described, in particular, above.

In particular, an entry license plate string based on image data of the license plate of the vehicle and entry raw signals from signal sources located in or at this vehicle can be detected during the driving through of the vehicle through the entry area and, in particular, provided to the data set generation module. The entry data set 488 generated by the data set generation module can be stored in step 303 after being received by the receiving module in step 301. In step 303, the received entry data set 488 is stored in a data memory by at least one storage module of the data processing device.

In a further step 305 (in particular, after the parking process of the parked vehicle has been completed), a receiving is performed, by the receiving module, of an exit data set 490 containing an exit license plate string of a vehicle driving out of the parking device determined by a second license plate recognition equipment, and at least one raw exit signal detected by an exit signal detection equipment in an exit area of the parking device during the driving out of the vehicle, as described, in particular, above.

In a next step 307, a determining is performed, by at least one evaluation module of the data processing device, of an entry data set corresponding to the received exit data set 490 from the stored entry data sets by means of a comparing (carried out in step 307) in a first comparison step, of the exit license plate string of the exit data set with the entry license plate strings of the stored entry data sets

If it is determined in the first comparison step that the compared license plate strings are identical, the evaluation module determines that the received exit data set 490 corresponds to an entry data set 488 from the stored entry data sets. In other words, it is determined in step 309 that the entry data set 488 and the exit data set 490 originate from the same vehicle. Entry data set 488 and exit data set 490 are assigned to each other.

As has already been described, optionally, a parking duration can be determined, a release of the vehicle access device of the exit can be caused, a billing can be performed, and/or the like.

If no identity is determined in the first comparison step in step 307 (as shown in the example in FIG. 4), the process continues with step 311.

In step 311, a comparing is performed, in a second comparison step, (only) of the at least one exit raw signal of the (received) exit data set 490 with the entry raw signal of the at least one entry data set 488 of the stored entry data sets which contains the entry license plate string that is most similar to the exit license plate string of the exit data set 490, at least then, preferably only then, if in the first comparison step (see step 307) no entry license plate string identical to the exit license plate string was determined.

It is particularly preferred that an intermediate step is first carried out in step 311 in order to determine at least the entry data set 488 whose entry license plate string is most similar to the exit license plate string of the exit data set 490. In variants of the invention, the entry data sets with the x most similar vehicle license plate strings can be determined.

In order to determine the aforementioned entry data set 488 respectively the most similar license plate strings, the evaluation module can be configured to determine a similarity factor between two license plate string strings 494, 496 compared in the first comparison step. In particular, the exit license plate string 496 of the exit data set 490 can be compared with all entry license plate strings 494 present in the stored entry data sets in order to determine the respective similarity factor. The respective similarity factor is determined, in particular, based on measuring a respective Levenshtein distance between the compared license plate strings 494, 496. In the embodiment shown in FIG. 4, the determined Levenshtein distance between the compared license plate strings 494, 496 is equal to 1.

The evaluation module can be configured to at least determine the license plate strings that are most similar based on the similarity factors determined in each case.

Preferably, the evaluation module can be configured to dynamically determine a matching criterion based on the similarity factor of the license plate strings 494, 496 that are most similar. The more dissimilar the license plate strings 494, 496 are (for example, the greater the Levenshtein distance is), the higher the match between the at least one entry raw signal 498 and the at least one exit raw signal 492 must be.

According to the invention, the exit data set 490 can also be assigned to an entry data set 488 if no identity of the license plate strings is determined in the first comparison step, but the at least one entry raw signal 498 of the entry data set 488 is most similar to the entry license plate string 494, which is most similar to the exit license plate string 496 of the exit data set 490, and the at least one exit raw signal 492 of the exit data set 490 fulfills the at least one matching criterion.

The matching criterion specifies, in particular, when there is sufficient matching between the at least one entry raw signal 498 and the at least one exit raw signal 490 to ensure that the entry data set 488 and the exit data set 490 originate from the same vehicle. Comparing the at least one entry raw signal 498 with the at least one exit raw signal 492 in the second comparison step (step 311) may, in particular, comprise determining the matching signal parts (e.g., a (pure) comparison of the respective bit streams). In particular, it has been recognized that parts of the payload transmitted by a signal source may change at least partially over time, i.e., in particular between the entry time and the exit time. The number of entry raw signals can also be compared with the number of exit raw signals.

In the present case, the evaluation module can, for example, arrive at a matching value of 40% when comparing the raw signals 498 and 492 mentioned above. The dynamically determined matching threshold value of the matching criterion can be, for example, 35% based on the determined similarity factor. Therefore, in the present example, the evaluation module can determine that the received exit data set 490 corresponds to the entry data set 488. It is possible to continue with step 309.

In a further embodiment, in the second comparison step 311, a respective intersection of the respective entry raw signals 498 with the exit raw signal 492 can be formed, and the entry data set 488 corresponding to the exit data set 490 can be determined from the totality of all entry data sets as the one whose entry raw signal 498 forms the largest respective intersection with the exit raw signal 492 of the exit data set 490. In FIG. 4, the largest intersection of the shown entry raw signal 498 and the shown exit raw signal 492 has the value 5: The longest matching character string “qwertz” is 5 characters long. If, in the second comparison step 311, no other pairing can be found between the exit raw signal 492 and the entirety of the stored entry raw signals whose intersection is greater than or equal to 5, then the evaluation module can determine in the present example that the received exit data set 490 corresponds to the entry data set 488. It is possible to continue with step 309.

If the evaluation module determines that the matching criterion is not met, it can be continued with step 313, in which no assignment is performed and, for example, a corresponding error message is issued. Subsequently, measures to remedy the problem can be initiated, for example, by an employee of the parking system operator.

### LIST OF REFERENCE SIGNS

100 Data processing device
102 Processor
104 Memory means
106 Receiving module
107 Data set unification module
108 Evaluation module
110 Storage module
112 Data memory
200 Data processing device
202 Processor
204 Memory means
206 Receiving module
207 Data set unification module
208 Evaluation module
210 Storage module
212 Data memory
214 Communication module
216 Image evaluation module
218 Data set generation module
220 Release module
222 Parking duration determination module
224 Billing module
226 Vehicle access device
227 User database
228 Update module
230 Parking system
232 Entry
234 Exit
236 Entry area
238 Exit area
240 Entry signal detection equipment
242 Exit signal detection equipment
244 Receiver
246 Receiver
248 Receiver
250 License plate recognition equipment
252 License plate recognition equipment
254 Camera
256 Camera
258 Vehicle access device
260 Base
262 Barrier boom
264 Detection field
266 Detection field
268 Detection range
270 Detection field
272 Detection range
274 Vehicle
276 Mobile device
278 Wheel sensor
280 Entertainment system
282 Data communication network
301 Step
303 Step
305 Step
307 Step
309 Step
311 Step
313 Step
488 Entry data set
490 Exit data set
492 Exit raw signal
494 Entry license plate string
496 Exit license plate string
498 Entry raw signal

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A data processing device for a parking system, comprising:
at least one receiving module configured to receive an entry data set containing an entry license plate string determined by a first license plate recognition equipment of a vehicle driving into a parking device of the parking system and at least one entry raw signal detected by an entry signal detection equipment in an entry area of the parking device during the driving in of the vehicle,
at least one storage module configured to store the received entry data set in a data memory,
wherein the receiving module is configured to receive an exit data set containing an exit license plate string determined by a second license plate recognition equipment of a vehicle driving out of the parking device and at least one exit raw signal detected by an exit signal detection equipment in an exit area of the parking device during the driving out of the vehicle, and
at least one evaluation module configured to determine an entry data set corresponding to the received exit data set from the stored entry data sets by:
comparing, in a first comparison step, the exit license plate string of the exit data set with the respective entry license plate strings of the stored entry data sets, and
comparing, in a second comparison step, the at least one exit raw signal of the exit data set with the entry raw signal of the at least one entry data set of the stored entry data sets which contains the entry license plate string that is most similar to the exit license plate string of the exit data set.

2. The data processing device according to claim 1, wherein
the evaluation module is configured to perform the second comparison step only if no entry license plate string identical to the exit license plate string was determined in the first comparison step.

3. The data processing device according to claim 1, wherein
the evaluation module is configured to compare, in the second comparison step, the at least one exit raw signal of the exit data set with the at least one entry raw signal of the entry data set of the stored entry data sets that contains the entry license plate string that is most similar to the exit license plate string of the exit data set without determining the data content of the at least one exit raw signal and/or without determining the data content of the at least one entry raw signal.

4. The data processing device according to claim 1, wherein
the evaluation module is configured to determine an entry data set corresponding to the received exit data set from the stored entry data sets if
in the first comparison step, it is determined that the entry license plate string of the corresponding entry data set is identical to of the exit license plate string of the received exit data set,
in the second comparison step, it is determined that the entry raw signal of the corresponding entry data set and the exit raw signal of the received exit data set satisfy a matching criterion.

5. The data processing device according to claim 1, wherein
the evaluation module is configured to determine a similarity factor between two license plate strings compared in the first comparison step based on measuring a Levenshtein distance between the compared license plate strings,
and the evaluation module is configured to at least determine the license plate strings that are most similar to each other based on the determined similarity factors.

6. The data processing device according to claim 4, wherein
the evaluation module is configured to dynamically determine the matching criterion based on the similarity factor of the license plate strings that are most similar.

7. The data processing device according to claim 1, wherein
the entry data set contains a plurality of detected entry raw signals transmitted by a corresponding plurality of transmitting devices,
the exit data set contains a plurality of detected exit raw signals transmitted by a corresponding plurality of transmitting devices.

8. The data processing device according to claim 7, wherein
a transmitting device is selected from the group, comprising:
mobile terminal,
wheel sensor of the vehicle,
vehicle control device of the vehicle,
entertainment system of the vehicle,
on-board computer of the vehicle
Car-2-X interface of the vehicle.

9. The data processing device according to claim 1, wherein:
the data processing device comprises at least one release module configured to release a vehicle access device arranged in the exit area at least based on the evaluation result,
the entry data set contains an entry time point of the vehicle, and
the data processing device further comprises a parking duration determination module configured to determine the parking duration of the vehicle based on the entry time point of the vehicle and a provided exit time point of the vehicle.

10. The data processing device according to claim 1, further comprising:
at least one user database configured to store user data sets each containing at least one user identifier, a vehicle license plate, and at least one data field for storing raw signal data sets,
at least one update module configured to add the at least one entry raw signal from a received entry data set to the user data set whose vehicle license plate is identical to the entry license plate string of the received entry data set, and/or to add the at least one exit raw signal from a received exit data set to the user data set whose vehicle license plate is identical to the exit license plate string of the received exit data set.

11. The data processing device according to claim 10, wherein
the evaluation module is configured to determine a user data set corresponding to the received exit data set from the stored entry data sets by:
comparing, in a third comparison step, the exit license plate string of the exit data set with the respective vehicle license plates of the stored user data sets, and
comparing, in a fourth comparison step, the at least one exit raw signal of the exit data set with the at least one raw signal data set of the user data set of the stored user data sets which contains the vehicle license plate string which is most similar to the exit license plate string of the exit data set at least if no vehicle license plate string identical to the exit license plate string was determined in the third comparison step.

12. A parking system, comprising:
at least one data processing device according to claim 1,
at least one first license plate recognition equipment configured to determine an entry license plate string of a vehicle driving into a parking device,
at least one entry signal detection equipment configured to detect at least one entry raw signal in an entry area of the parking device during driving in of the vehicle,
at least one second license plate recognition equipment configured to determine an exit license plate string of a vehicle driving out of the parking device, and
at least one exit signal detection equipment configured to detect at least one raw exit signal in an exit area of the parking device during the driving out of the vehicle.

13. The parking system according to claim 12, further comprising
at least one vehicle access device arranged at the entry of the parking device with at least one blocking element,
wherein the entry signal detection equipment comprises at least one first receiver configured to provide a first detection field in a passageway in front of the blocking element, and at least one second receiver configured to provide a second detection field in the direction of passage behind the blocking element.

14. The parking system according to claim 13, comprising:
a data set unification module configured
to receive the entry license plate string of a vehicle driving into a parking device of the parking system, which is determined by the first license plate recognition equipment, and
to receive the at least one first entry raw signal detected by the first receiver in a first detection field during the driving in of the vehicle in front of the blocking element, and
to receive at least one second raw entry signal detected by the second receiver in a second detection field during driving in of the vehicle behind the blocking element,
to generate the entry data set containing as an entry license plate string the entry license plate string of the first entry data set and as an entry raw signal the intersection of the at least one detected first entry raw signal and the at least one detected second entry raw signal.

15. The parking system according to claim 12, further comprising
at least one vehicle access device arranged at the entry of the parking device without a blocking element,
wherein the entry signal detection equipment comprises at least one receiver configured to provide a third detection field,
wherein the first license plate recognition equipment comprises at least one camera arranged at the entry,
wherein a detection area of the camera and the third detection field at least partially overlap.

16. A method, comprising:
receiving, by a receiving module of a data processing device of a parking system, an entry data set containing an entry license plate string of a vehicle driving into a parking device, and at least one entry raw signal detected by an entry signal detection equipment in an entry area of the parking device during the driving in of the vehicle,
storing, by at least one storage module of the data processing device, of the received entry data set in a data memory,
receiving, by the receiving module, of an exit data set containing an exit license plate string determined by a second license plate recognition equipment of a vehicle driving out of the parking device and at least one exit raw signal detected by an exit signal detection equipment in an exit area of the parking device during the driving out of the vehicle,
determining, by at least one evaluation module of the data processing device, an entry data set corresponding to the received exit data set from the stored entry data sets by:
comparing, in a first comparison step, the exit license plate string of the exit data set with the respective entry license plate strings of the stored entry data sets, and/or
comparing, in a second comparison step, the at least one exit raw signal of the exit data set with the entry raw signal of the at least one entry data set of the stored entry data sets which contains the entry license plate string that is most similar to the exit license plate string of the exit data set.

17. A computer program comprising instructions which, when executed by at least one processor of a data processing device, cause the data processing device to execute and/or control the method according to claim 16.
